(19) United States
(12) Patent Application Publication
(10) Pub. No.: US 2009/0032665 A1
(43) Pub. Date: Feb. 5, 2009

(54) Overhead mounting apparatus

(76) Inventors: William Riley Smith, JR., Huntsville, AL (US); Jeffrey D. Carnevali, Seattle, WA (US)

Correspondence Address: CHARLES J RUPNICK, PO BOX 46752, SEATTLE, WA, 98146, US

(21) Appl. No.: 11/974,576

(22) Filed: Oct. 15, 2007

Related U.S. Application Data
(63) Continuation-in-part of application No. 11/881,993, filed on Jul. 30, 2007.

(51) Int. Cl. B42F 15/00; B23P 19/00

(52) U.S. Cl. 248/343; 29/700

(57) ABSTRACT

A novel overhead mounting bracket for mounting portable computers and other electronic computing devices in a vehicle above the dashboard thereof. The overhead mounting bracket includes at least an integrated receiver bracket having a substantially rigid integral base plate portion adapted for attachment to a roof portion of a vehicle adjacent to an interior surface thereof, a substantially rigid integral mounting plate portion spaced away from the base plate portion and having a mounting face angularly inclined relative thereto and being adapted for attachment thereto of a cradle structured for holding a portable computer or other electronic computing device, and a substantially rigid integral spacing plate portion coupled between the mounting plate portion and the base plate portion and spacing the mounting plate portion away therefrom.

The present application is a Continuation-in-part of co-pending U.S. patent application Ser. No. 11/881,993 filed in the name of the inventor of Jeffrey D. Carnevali on Jul. 30, 2007, which is incorporated in its entirety herein by reference.

### FIELD OF THE INVENTION

The present invention relates generally to mounting brackets for holding computing devices overhead in an on-road automobile passenger compartment of a type structured for carrying the vehicle's operator and/or passengers and, more particularly, to universal mounting brackets for portable computers and other electronic computing devices having a display screen and means for inputting data, control commands and/or other information thereto.

### BACKGROUND OF THE INVENTION

Mounting brackets are generally well-known for mounting portable computers and other electronic computing devices in an automobile passenger compartment or the passenger compartment of another on-road passenger vehicle such as a pick-up truck, van or minivan. However, to date such known mounting brackets have been mostly structured for supporting the computing device relative to the vehicle floor or passenger seat, thereby occupying valuable interior space that might otherwise be used for passengers or other equipment. The few currently known mounting brackets for supporting the computing device overhead in the vehicle have been consistently configured to receive only a specific computing device, and thus have limited severely limited by design considerations.

U.S. Pat. No. 7,236,863 “Docking Station For A Vehicle” issued to LaPorte, et al. on Jun. 26, 2007, which is incorporated herein by reference, on the other hand, a docking station adapted to receive a portable computer. As a docking station, the overhead mounting bracket of U.S. Pat. No. 7,236,863 is even more limited since it must include electrical connections capable of connecting the portable computer to subsystems such as an engine management system, a mobile phone holder, speakers and a navigation system. Furthermore, these electrical connections and attendant mechanical interfaces limit the overhead mounting bracket of U.S. Pat. No. 7,236,863 to one or at most a small family of portable computer make and model.

US Patent Application 2004/0061995 “Portable Computer Docking Station For Vehicles” filed in the name of Edward L. McMahon on Sep. 28, 2002, which is incorporated herein by reference, is another docking station for removably securing a portable computer to the ceiling of a vehicle in an upside down position in such manner that a video screen portion thereof is viewable by a vehicle occupant. However, the docking station of US Patent Application 2004/0061995 is limited by mechanical interfaces to accommodate one or at most a small family of portable computer make and model. The docking station of US Patent Application 2004/0061995 is further limited to portable computers that include software configured to rotate an image displayed on the video screen portion such that the image appears in a right-side-up viewing orientation with respect to a vehicle occupant because the docking station is structured to mount base of the portable computer device against the roof of the vehicle such that the image would normally appear up-side-down to the vehicle occupant absent such software.

Thus, it clear that known overhead mounting brackets are severely limited in their ability to provide even a limited degree of flexibility and adaptability for mounting portable computers and other electronic computing devices in the passenger compartment of an on-road automobile.

### SUMMARY OF THE INVENTION

The present invention is a novel overhead mounting bracket that overcomes flexibility and adaptability limitations of known overhead mounting brackets for mounting portable computers and other electronic computing devices in a conventional on-road passenger motor vehicle above the dashboard thereof.

According to one aspect of the invention, the novel overhead mounting bracket includes at least an integrated receiver bracket having a substantially rigid integral base plate portion adapted for attachment to a roof portion of a vehicle adjacent to an interior surface thereof, a substantially rigid integral mounting plate portion spaced away from the base plate portion and having a mounting face angularly inclined relative thereto and being adapted for attachment thereto of a cradle structured for holding a portable computer or other electronic computing device, and a substantially rigid integral spacing plate portion coupled between the mounting plate portion and the base plate portion and spacing the mounting plate portion away therefrom.

According to another aspect of the novel overhead mounting bracket, the base plate portion of the receiver bracket further includes a plurality of apertures formed therethrough, whereby the base plate portion is adapted for attachment to a roof portion of a vehicle adjacent to an interior surface thereof

According to another aspect of the novel overhead mounting bracket, the mounting plate portion of the receiver bracket further includes a plurality of apertures formed therein, whereby the mounting plate portion is adapted for attaching to the mounting face thereof a cradle structured for holding a portable computer or other electronic computing device.

According to another aspect of the novel overhead mounting bracket, the mounting face of the mounting plate portion of the receiver bracket is further angularly inclined relative to the base plate portion thereof at an angle in the range of approximately ten to thirty degrees from perpendicular.

According to another aspect of the novel overhead mounting bracket, one or more of the base plate portion, the mounting plate portion, and the spacing plate portion of the receiver bracket further includes means coupled thereto for stiffening.

According to another aspect of the novel overhead mounting bracket, the novel overhead mounting bracket further includes a substantially rigid mounting frame adapted for attachment to a roof portion of a vehicle adjacent to an interior surface thereof; and a substantially rigid spacing arm coupled between the base plate portion of the receiver bracket and the mounting frame and spacing the base plate portion away therefrom.

According to another aspect of the novel overhead mounting bracket, the spacing arm further includes a first portion thereof coupled to the mounting frame and a second portion thereof spaced away therefrom. The base plate portion of the receiver bracket is coupled to the, the second portion of the spacing arm and is optionally being relatively rotatably thereto. Optionally, means are further included for adjusting rotatability between the base plate portion of the receiver bracket and second portions of the spacing arm.

According to another aspect of the novel overhead mounting bracket, the mounting frame further includes a first substantially rigid frame member and a second substantially rigid frame member, the second frame member being spaced away from the first frame member and coupled thereto by a plurality of fasteners coupled therebetween.

According to another aspect of the invention, a novel method is provided for operating the novel overhead mounting bracket for suspending a portable computer and other electronic computing devices in a conventional on-road passenger vehicle such as an automobile, a pick-up truck, van or minivan in a position above the dashboard thereof, the suspending method including: providing a mounting bracket including at least a receiver bracket having: a substantially rigid base plate portion adapted for attachment to the vehicle roof portion adjacent to the interior surface thereof, a substantially rigid mounting plate portion spaced away from the base plate portion and having a mounting face angularly inclined relative thereto and being adapted for attachment thereto of a cradle structured for holding a portable computer or other electronic computing device, and a substantially rigid spacing plate portion coupled between the mounting plate portion and the base plate portion and spacing the mounting plate portion away therefrom. The suspending method further includes: substantially permanently coupling the mounting bracket to a roof portion of a vehicle adjacent to an interior surface thereof with the mounting face of the mounting plate portion being obtusely angularly inclined relative to the interior surface of the vehicle roof portion at an angle in the range of approximately ten to thirty degrees from perpendicular; and to the mounting face of the mounting plate portion of the mounting bracket, substantially permanently attaching a cradle structured for holding a portable computer or other electronic computing device having a display screen, the cradle being oriented on the mounting face of the mounting plate for holding the device with the display screen thereof in a substantially vertical viewing orientation relative to the vehicle having an upper portion of a view displayed thereon in an upper portion thereof adjacent to the vehicle roof portion and a lower portion thereof spaced away from the vehicle roof portion.

According to another aspect of the novel method of operating the novel overhead mounting bracket for suspending a portable computer and other electronic computing devices in a vehicle above the dashboard thereof, the method further includes mounting a portable computer or other electronic computing device in the cradle with the display screen thereof in the substantially vertical viewing orientation.

According to another aspect of the novel method of operating the novel overhead mounting bracket for suspending a portable computer and other electronic computing devices in a vehicle above the dashboard thereof, the attaching a cradle to the mounting plate portion of the mounting bracket further includes coupling a plurality of fasteners between an interface portion of the cradle and corresponding apertures formed in the mounting plate portion.

According to another aspect of the novel method of operating the novel overhead mounting bracket for suspending a portable computer and other electronic computing devices in a vehicle above the dashboard thereof, the coupling the mounting bracket to the roof portion of the vehicle adjacent to the interior surface thereof further includes: coupling a substantially rigid mounting frame to the roof portion of the vehicle adjacent to the interior surface thereof; coupling a substantially rigid spacing arm to the mounting frame; and coupling the base plate portion of the receiver bracket to the spacing arm in a spaced away relationship to the mounting frame.

According to another aspect of the novel method of operating the novel overhead mounting bracket for suspending a portable computer and other electronic computing devices in a vehicle above the dashboard thereof the coupling the mounting bracket to the roof portion of the vehicle adjacent to the interior surface thereof further includes relatively rotatably coupling the base plate portion of the receiver bracket to the spacing arm to the mounting frame for relative rotation substantially about an axis between the mounting frame and the base plate portion of the receiver bracket.

According to another aspect of the novel method of operating the novel overhead mounting bracket for suspending a portable computer and other electronic computing devices in a vehicle above the dashboard thereof, the coupling the mounting bracket to the roof portion of the vehicle adjacent to the interior surface thereof further includes: positioning a first substantially rigid frame member of the mounting frame adjacent to the interior surface of the roof portion of the vehicle; positioning a second substantially rigid frame member of the mounting frame adjacent to an exterior surface of the roof portion of the vehicle spaced away from the interior surface thereof and substantially aligned with first frame member; and coupling a plurality of fasteners between the first and second frame members.

According to another aspect of the novel method of operating the novel overhead mounting bracket for suspending a portable computer and other electronic computing devices in a vehicle above the dashboard thereof, the substantially permanently coupling the mounting bracket to a roof portion of a vehicle adjacent to an interior surface thereof is further limited to substantially permanently coupling the mounting bracket to a roof portion of a conventional on-road passenger vehicle such as an automobile, a pick-up truck, van or minivan adjacent to an interior surface thereof in a position above a dashboard thereof.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is an illustrative example of the novel overhead mounting bracket mounted in a conventional automobile type on-road motor vehicle;

FIG. 2 is another illustrative example of the novel overhead mounting bracket mounted in a conventional pick-up truck type on-road motor vehicle;

FIG. 3 illustrates the novel overhead mounting bracket by example and without limitation as an integrated receiver bracket;

FIG. 4 illustrates the integrated receiver bracket of the novel overhead mounting bracket having a cradle substantially permanently attached to a mounting plate portion of the integrated receiver bracket for holding a portable computer or other electronic computing device;

FIG. 5 is an isometric view that illustrates the integrated receiver bracket of the novel overhead mounting bracket having the cradle substantially permanently attached to an inclined mounting face of a mounting plate portion of the integrated receiver bracket for holding a portable computer or other electronic computing device;

FIG. 6 is another view of the novel overhead mounting bracket that illustrates a mounting frame member in combination with the integrated receiver bracket;

FIG. 7 is another view of the novel overhead mounting bracket that illustrates the mounting frame member in combination with the integrated receiver bracket;

FIG. 8 is another view of the novel overhead mounting bracket that illustrates the mounting frame member in combination with the integrated receiver bracket;

FIG. 9 is another view of the novel overhead mounting bracket that illustrates the mounting frame member in combination with the integrated receiver bracket;

FIG. 10 is another view of the novel overhead mounting bracket that illustrates the mounting frame member as being optionally formed of a single monolithic spacing arm portion securely attached to the mounting frame, as for example by a peripheral weldment;

FIG. 11 is another view of the novel overhead mounting bracket that illustrates the mounting frame member as being optionally formed of a single monolithic spacing arm portion securely attached to the mounting frame; and

FIG. 12 is still another view of the novel overhead mounting bracket that illustrates the mounting frame member as being optionally formed of a single monolithic spacing arm portion securely attached to the mounting frame.

### DETAILED DESCRIPTION OF PREFERRED EMBODIMENT

In the Figures, like numerals indicate like elements.

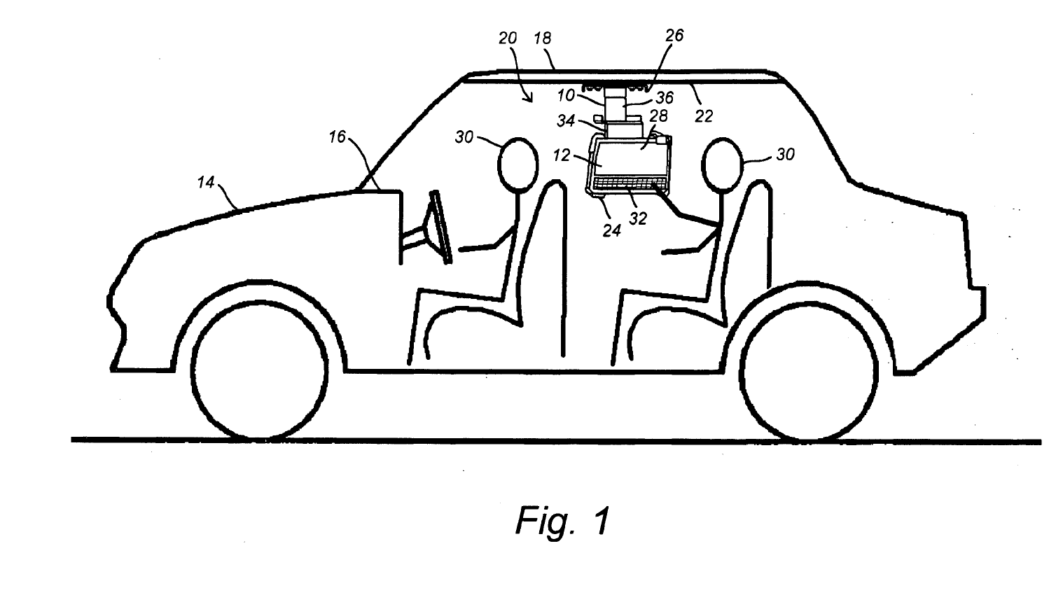

FIG. 1 illustrates one example of a mounting bracket of the invention as an overhead mounting bracket 10 for mounting portable computers and other electronic computing devices 12 in a conventional on-road motor vehicle 14 above a dashboard portion 16 thereof By example and without limitation, the electronic computing device 12 is any conventional laptop computer having any of a built-in keyboard, a remote keyboard, or a touch-screen for input thereto. Alternatively, the electronic computing device 12 is any Convertible Notebook personal computer, for example of the type commercially available from Gateway, Inc.® that permits use of a full-size keyboard and 14 inch widescreen display for day-to-day computing needs, and permits the user to swivel and switch the display screen to transform the it into tablet form for writing directly on the screen for inputting information using a special pen called a stylus which also operates as a mouse to do things like select, drag and open files. The electronic computing device 12 is also alternatively any conventional tablet type personal computer or tablet PC which is a wireless personal computer (PC) similar in size and thickness to a yellow paper notepad and allows a user to take notes using natural handwriting with a stylus or digital pen on a touch screen. A conventional remote computer monitor may also be substituted as the computing-type electronic device 12.

By example and without limitation, the overhead mounting bracket 10 is illustrated here as being substantially permanently coupled to a roof portion 18 of the vehicle 14 for suspending the portable computer or other electronic computing device 12 therefrom within an occupant compartment 20 thereof, where the motor vehicle 14 is illustrated as being of an automobile type. The overhead mounting bracket 10 is adapted for attachment to the vehicle roof portion 18 adjacent to an interior surface 22 thereof. The overhead mounting bracket 10 is further adapted for substantially permanent attachment thereto of a cradle 24 for holding the specific computing device 12, usually specific to the device type and brand and may be specific to the model and even the model year of manufacture. The overhead mounting bracket 10 is further adapted for suspending the cradle 24 holding the computing device 12 in an angularly inclined relationship to the interior surface 22 of the vehicle roof portion 18 at an obtuse angle by means of a substantially rigid mounting frame member 26. In other words, the cradle 24 is suspended by the mounting frame member 26 at to the interior surface 22 of the vehicle roof portion 18 an acute angle from perpendicular thereto, for example in the range of approximately ten to thirty degrees from perpendicular thereto. The overhead mounting bracket 10 is adapted for attachment of the cradle 24 such that, when the computing device 12 mounted therein is of a type having a display screen 28 as illustrated, the cradle 24 is oriented relative to the overhead mounting bracket 10 for holding the computing device 12 with its display screen 28 in a substantially vertical viewing orientation relative to the occupant compartment 20 of the motor vehicle 14 and an occupant 30 resident therein by having an upper portion of a view displayed thereon in an upper portion thereof adjacent to the vehicle roof portion 18 and a lower portion thereof spaced away from the vehicle roof portion 18.

Furthermore, when the computing device 12 mounted therein is of a type having a means for inputting data such as a keyboard 32 as illustrated or other data inputting means, the overhead mounting bracket 10 is adapted for attachment of the cradle 24 such that, the cradle 24 is oriented relative to the overhead mounting bracket 10 for holding the computing device 12 with its keyboard 32 or other data inputting means in a substantially vertical operating orientation relative to the vehicle occupant compartment 20 and its occupant 30 by having character key identifiers displayed thereon in a substantially upright orientation relative to the interior surface 22 of the vehicle roof portion 18.

Optionally, the overhead mounting bracket 10 includes a substantially rigid integrated receiver bracket portion 34 which is adapted for substantially permanent attachment thereto of the cradle 24 for holding the computing device 12. Additionally, the overhead mounting bracket 10 includes a substantially rigid spacing arm 36 coupling the integrated receiver bracket portion 34 to the mounting frame 26 in a spaced away relationship thereto, whereby the integrated receiver bracket portion 34 and the cradle 24 attached thereto are suspended away from the interior surface 22 of the vehicle roof portion 18.

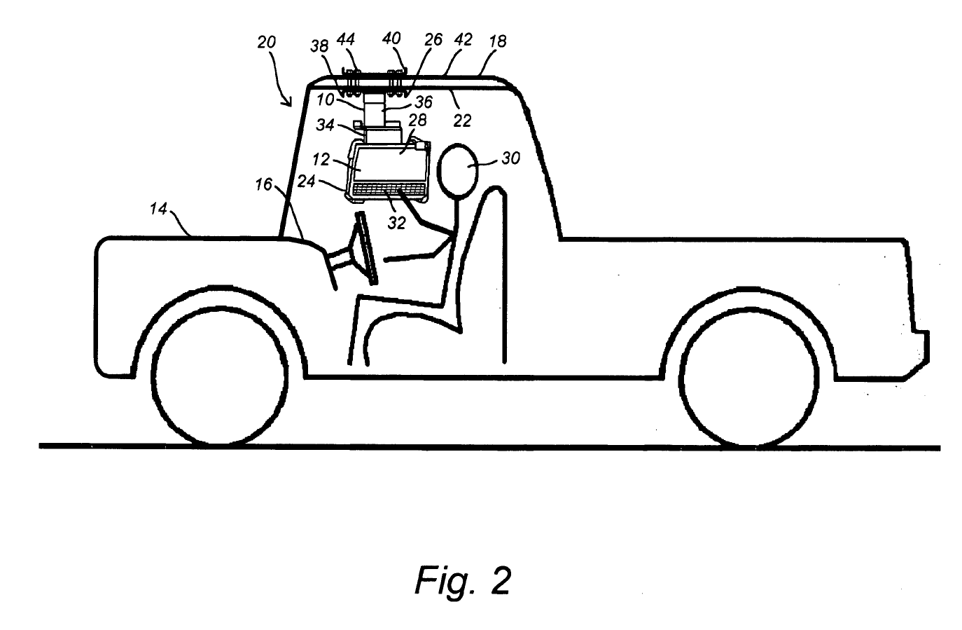

FIG. 2 illustrates the overhead mounting bracket 10 by example and without limitation as being substantially permanently attached to the roof portion 18 of another on-road passenger type motor vehicle 14, such as a pick-up truck or another on-road passenger vehicle such as a van or minivan, adjacent to the interior surface 22 thereof Here, the mounting frame 26 coupling the integrated receiver bracket portion 34 and the spacing arm 36 to the truck roof portion 18 includes both first and second substantially rigid frame plates 38 and 40 with the first frame plate 38 positioned adjacent to the roof interior surface 22 and the second frame plate 40 spaced away therefrom in a position adjacent to an exterior surface 42 of the vehicle roof portion 18 and substantially aligned with the first frame plate 38. A plurality of coupling fasteners 44 are coupled between the first and second frame plates 38, 40.

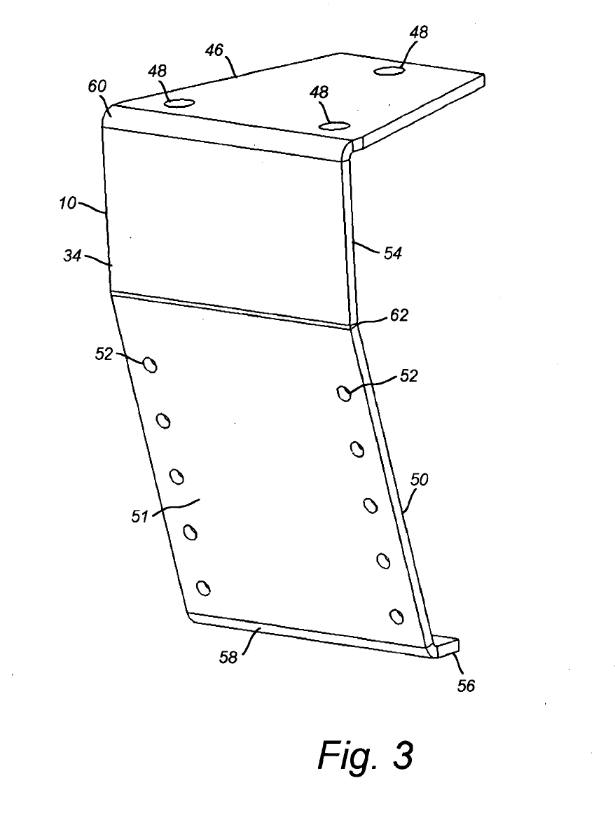

FIG. 3 illustrates the overhead mounting bracket 10 by example and without limitation as the integrated receiver bracket 34 having a substantially rigid integral base plate portion 46 adapted for attachment to the roof portion 18 of one of the motor vehicles 14 adjacent to the interior surface 22 thereof By example and without limitation, the base plate portion 46 optionally includes a plurality of apertures 48 formed therethrough for attachment to the motor vehicle roof portion 18. Other attachment means are also contemplated and may be substituted without deviating from the scope and intent of the present invention.

The integrated receiver bracket 34 also includes a substantially rigid integral mounting plate portion 50 spaced away from the base plate portion 46 and having a substantially planar mounting face 51 angularly inclined relative thereto. For example, the mounting plate portion 50 is angularly inclined relative to the base plate portion 46. The integral mounting plate portion 50 is adapted for attachment thereto of the cradle 24 for holding a portable computer or other electronic computing device 12. By example and without limitation, the mounting plate portion 50 optionally includes a plurality of apertures 52 formed therethrough for substantially permanent attachment of the cradle 24. Other attachment means are also contemplated and may be substituted without deviating from the scope and intent of the present invention. A substantially rigid integral spacing plate portion 54 of the integrated receiver bracket 34 is coupled between the mounting plate portion 50 and the base plate portion 46 and spaces the mounting plate portion 50 away from the base plate portion 46. At least the mounting face 51, and optionally the mounting plate portion 50 of the integrated receiver bracket 34, is further angularly inclined relative to the base plate portion 46 thereof at an angle in the range of approximately ten to thirty degrees from perpendicular.

Optionally, one or more of the base plate portion 46, the mounting plate portion 50, and the spacing plate portion 54 of the integrated receiver bracket 34 also includes stiffening means 56 coupled thereto for increased stiffening thereof As illustrated here, for example, the mounting plate portion 50 includes the stiffening means 56 as a bent portion thereof coupled along one edge 58 opposite from the spacing plate portion 54. The stiffening means 56 is also provided by the interconnected base plate portion 46, mounting plate portion 50, and spacing plate portion 54 of the integrated receiver bracket 34 by a mutually out-of-plane relationship along the respective intersecting edges 60 and 62 therebetween.

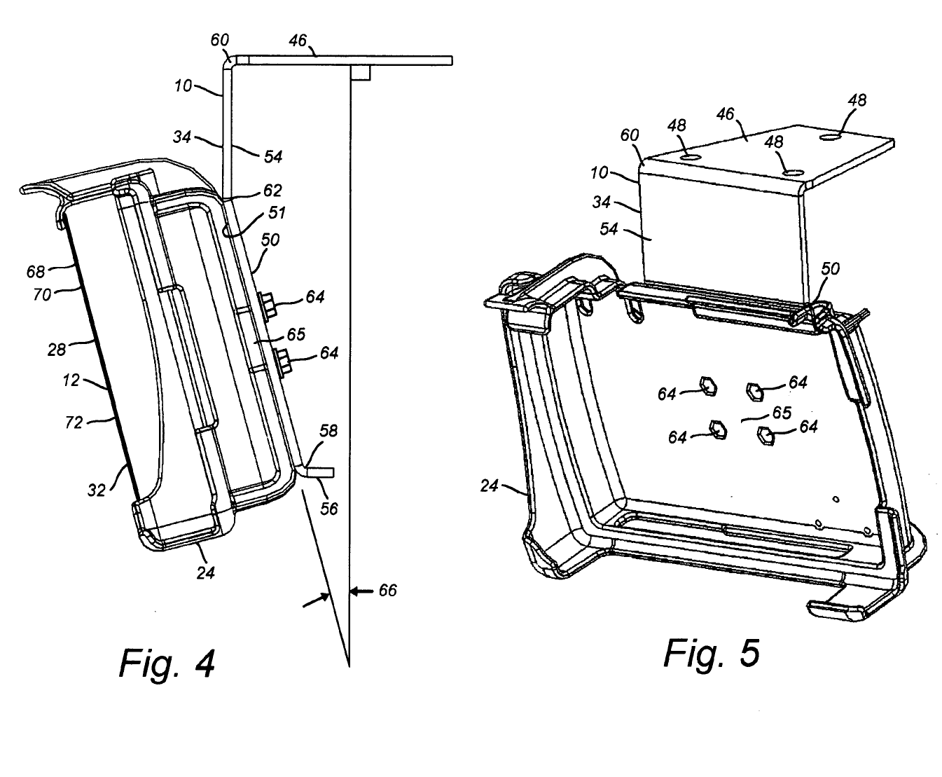

FIG. 4 illustrates the integrated receiver bracket 34 of the overhead mounting bracket 10 having the cradle 24 substantially permanently attached to the mounting plate portion 50 for holding a portable computer or other electronic computing device 12. By example and without limitation, the cradle 24 is optionally attached by a plurality of fasteners 64 through an interface portion 65 of the cradle 24 and corresponding ones of the apertures 52 in the mounting plate portion 50.

As illustrated here, the substantially rigid integral spacing plate portion 54 of the integrated receiver bracket 34 spaces the mounting plate portion 50 away from the base plate portion 46. The integral spacing plate portion 54 also angularly inclines at least the mounting face 51, and optionally the mounting plate portion 50, relative to the base plate portion 46 at an acute angle 66 by example and without limitation in the range of approximately ten to thirty degrees from perpendicular. Accordingly, the overhead mounting bracket 10 causes the cradle 24 attached to the mounting face 51 of the mounting plate portion 50 to be suspended at the same angle 66 in the range of approximately ten to thirty degrees from perpendicular relative to the base plate portion 46.

The overhead mounting bracket 10 is thus adapted for attachment of the cradle 24 such that, when the computing device 12 is mounted therein, as illustrated, its display screen 28 is oriented at substantially the same angle 66 as the mounting face 51 of the mounting plate portion 50. When the overhead mounting bracket 10 is mounted by the base plate portion 46 of its integrated receiver bracket 34, the display screen 28 of the resident computing device 12 is oriented right-side-up relative to the vehicle roof portion 18. Accordingly, the display screen 28 is oriented in a substantially vertical viewing orientation relative to the occupant compartment 20 of the motor vehicle 14 so that the occupant 30 resident therein observes an upper portion of a view 68 displayed thereon in an upper portion 70 thereof adjacent to the vehicle roof portion 18 and a lower portion 72 thereof spaced away from the vehicle roof portion 18.

Furthermore, when the resident computing device 12 is of a type having the keyboard 32 or other data inputting means, the overhead mounting bracket 10 suspends the cradle 24 such that the keyboard 32 is presented in a substantially vertical operating orientation relative to the vehicle occupant compartment 20 and its occupant 30 by having character key identifiers displayed thereon in a substantially upright orientation relative to the interior surface 22 of the vehicle roof portion 18.

FIG. 5 is an isometric view that illustrates the integrated receiver bracket 34 of the overhead mounting bracket 10 having the cradle 24 substantially permanently attached to the mounting face 51 of the mounting plate portion 50 for holding a portable computer or other electronic computing device 12. By example and without limitation, the cradle 24 is illustrated here as being attached by the plurality of fasteners 64 through the apertures 52 in the mounting plate portion 50.

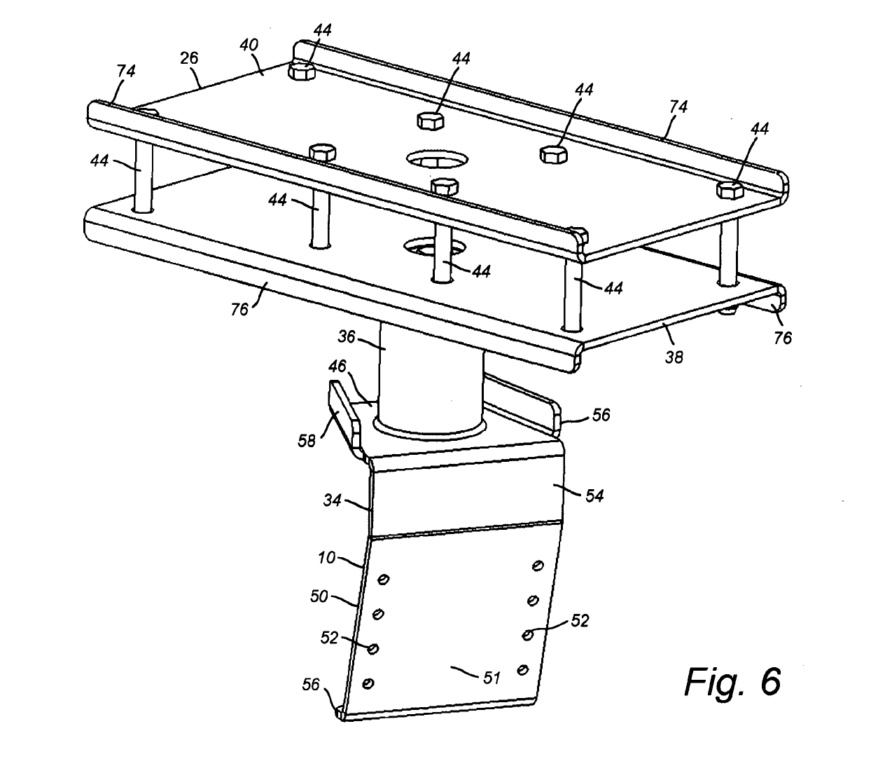

FIG. 6 is another view of the overhead mounting bracket 10 that illustrates the mounting frame member 26 in combination with the integrated receiver bracket 34. Here, the substantially rigid spacing arm 36 is coupled for positioning the integrated receiver bracket portion 34 in a spaced away relationship to the mounting frame 26. Here, the first and second substantially rigid frame plates 38 and 40 are illustrated as including optional respective integral stiffening portions 74 and 76. Additionally, the base plate portion 46 of the integrated receiver bracket portion 34 is illustrated having a pair of the optional integral stiffening portions 56.

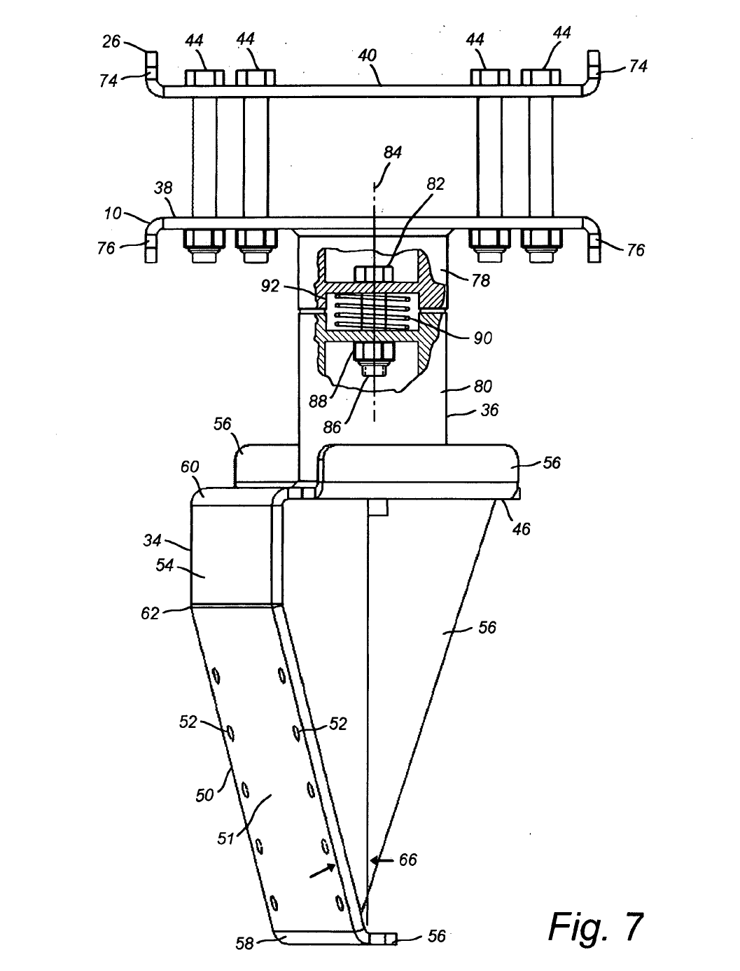

FIG. 7 is another view of the overhead mounting bracket 10 that illustrates the mounting frame member 26 in combination with the integrated receiver bracket 34. Here, the spacing arm 36 for positioning the integrated receiver bracket portion 34 in a spaced away relationship to the mounting frame 26 is illustrated by example and without limitation as being optionally formed of interconnected first and second spacing arm portions 78 and 80. By example and without limitation, the first and second spacing arm portions 78 and 80 are respectively coupled to the first or interior frame plate 38 of the mounting frame 26 and the base plate portion 46 of the integrated receiver bracket 34. When present, the first and second spacing arm portions 78 and 80 are relatively rotatably coupled by a fastener 82 for relative rotation substantially about an axis 84 extending between the mounting frame 26 and the base plate portion 46. Accordingly, the integrated receiver bracket 34 is rotatable relative to the mounting frame 26 when the mounting frame 26 is substantially permanently coupled to the roof portion 18 of the motor vehicle 14.

Optionally, the fastener 82 rotatably coupling the first and second spacing arm portions 78 and 80 is an adjustable fastener, such as a threaded bolt 86 and mating nut 88 as illustrated. Adjustably tightening or loosening the mating nut 88 relative to the threaded bolt 86 alternatively increases and decreases tension between the spacing arm portions 78 and 80 such that rotatability therebetween is adjustable. A compression spring or other expansive biasing member 90 is optionally installed between the first and second spacing arm portions 78 and 80, for example in a cavity 92 formed therebetween. The biasing member 90, when present, tends to separate the first and second spacing arm portions 78 and 80 when the coupling fastener 82 is loosened so that the integrated receiver bracket 34 is more easily rotatable relative to the mounting frame 26.

Additionally, as illustrated here one of the optional integral stiffening portions 56 conjoins the base plate portion 46, the mounting plate portion 50 and the spacing plate portion 54 of the integrated receiver bracket portion 34 with the mounting face 51 inclined at the angle 66 in the range of approximately ten to thirty degrees from perpendicular relative to the base plate portion 46. The conjoining stiffening portion 56 effectively maintains the angle 66 of inclination between the mounting face 51 of the mounting plate portion 50 and the base plate portion 46.

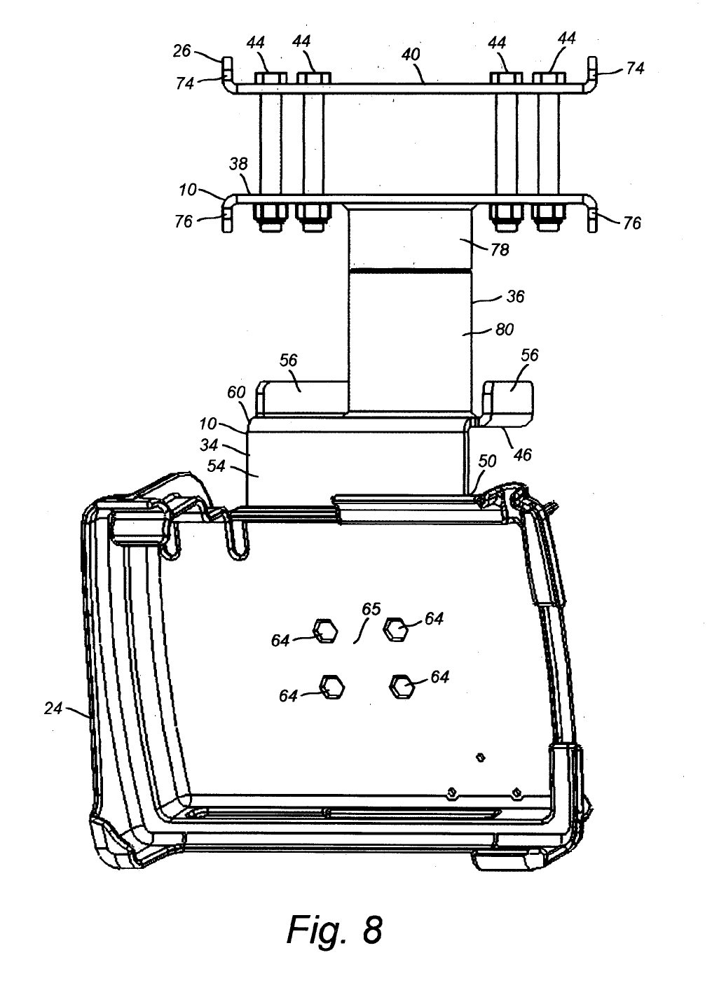

FIG. 8 is another view of the overhead mounting bracket 10 that illustrates the mounting frame member 26 in combination with the integrated receiver bracket 34. Here, the cradle 24 is substantially permanently attached to the angularly inclined mounting face 51 of the mounting plate portion 50, for example by the plurality of fasteners 64 inserted through the interface portion 65 of the cradle 24 and the corresponding apertures 52 in the mounting plate portion 50.

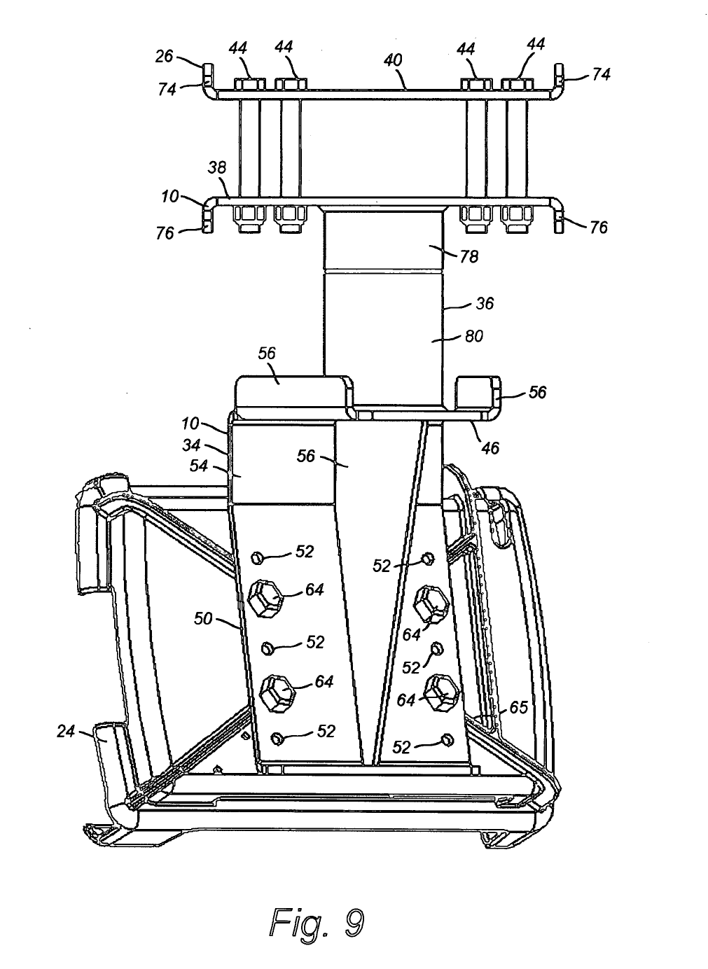

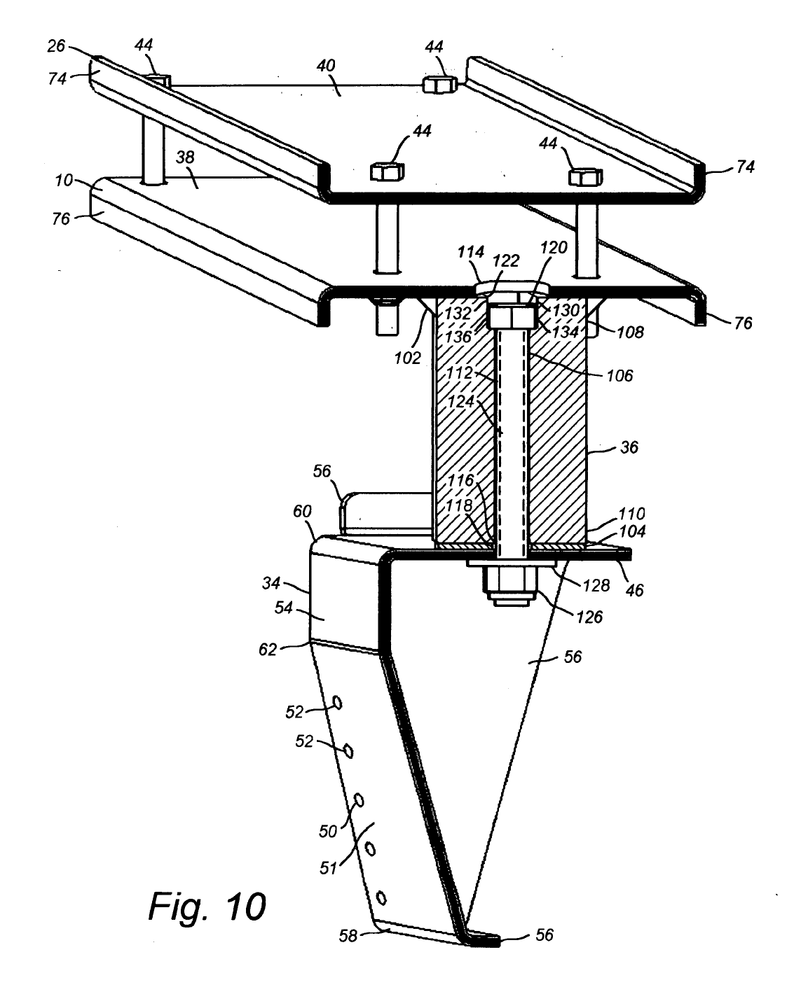

FIG. 9 is another view of the overhead mounting bracket 10 that illustrates the mounting frame member 26 in combination with the integrated receiver bracket 34. Here, the cradle 24 is substantially permanently attached to the angularly inclined mounting face 51 of the mounting plate portion 50, for example by the plurality of fasteners 64 inserted through the interface portion 65 of the cradle 24 and the corresponding apertures 52 in the mounting plate portion 50.

FIG. 10 is another view of the overhead mounting bracket 10 that illustrates the mounting frame member 26 in combination with the integrated receiver bracket 34. Here, the spacing arm 36 for positioning the integrated receiver bracket portion 34 in a spaced away relationship to the mounting frame 26 is illustrated by example and without limitation as being optionally formed of a single monolithic spacing arm portion securely attached to the mounting frame 26, as for example by a peripheral weldment 102. However, the spacing arm 36 is optionally secured in another conventional fashion, as by one or more fasteners, to the mounting frame 26. Accordingly, other attachment means are also contemplated and may be substituted for peripheral weldment 102 without deviating from the scope and intent of the present invention.

The spacing arm 36 is extended to an appropriate length as selected for the application. A low friction washer or bushing 104 is provided between the spacing arm 36 and the receiver bracket 34. The inverse relationship is also contemplated and may be substituted without deviating from the scope and intent of the present invention, whereby the spacing arm 36 is secured to the receiver bracket 34, and the low friction bushing 104 is provided between the spacing arm 36 and the mounting frame 26.

The spacing arm 36 is formed with a tubular aperture 106 therethrough between a first end 108 adjacent to the mounting frame 26 and a second end 110 adjacent to the receiver bracket 34. An elongated fastener 112, such as a bolt or threaded rod, is extended through the aperture 106 between an access aperture 114 formed through the first frame plate 38 substantially in alignment with the aperture 106 and through clearance apertures 116 and 118 formed through the low friction bushing 104 and the base plate portion 46 of the receiver bracket 34, respectively, also substantially in alignment with the aperture 106.

The fastener 112 has a lock nut or bolt head 120 (shown) captured in recess 122 in the first end 108 of the spacing arm 36 adjacent to the aperture 106. A threaded shaft 124 of the fastener 112 extends through respective clearance apertures 116, 118 of the low friction bushing 104 and the base plate portion 46 of the receiver bracket 34. A lock nut 126 secures the receiver bracket 34 relative to the fastener 112 with a washer 128, for example a second low friction bushing or washer, between the lock nut 126 and the base plate portion 46. The lock nut 126 is optionally secured loosely enough to permit rotation of the receiver bracket 34 relative to the spacing arm 36 and mounting frame 26. Else, the lock nut 126 is optionally secured sufficiently tightly to constrain the receiver bracket 34 from turning relative to the spacing arm 36 and mounting frame 26.

The recess 122 in the spacing arm 36 is provided adjacent to the first end 108 and substantially in alignment with the aperture 106. The recess 122 permits the frame plate 38 to be snugged against the roof interior surface 22 without interference from the lock nut or bolt head 120 on the fastener 112. The recess 122 and access aperture 114 are optionally both sized to permit a socket or wrench to seat on the nut or bolt head 120 while the lock nut 126 on the other end is being tightened or loosened.

Alternatively, the recess 122 is structured to independently constrain the nut or bolt head 120 while the lock nut 126 is turned. For example, the recess 122 is a multisided recess substantially matched in size and shape to the nut or bolt head 120, e.g., a hexagonal recess 122 is matched to a hexagonal bolt head 120. The recess 122 is alternatively a transverse slot formed in the first end 108 of the spacing arm 36 crosswise of the tubular aperture 106 and having opposing interior side walls 130, 132 spaced apart to receive therebetween opposing flats 134, 136 of the nut or bolt head 120. Interference between the recess's interior side walls 130, 132 and the respective flats 134, 136 of the nut or bolt head 120 constrain the fastener 112 from rotating when the lock nut 126 is turned on the shaft 124.

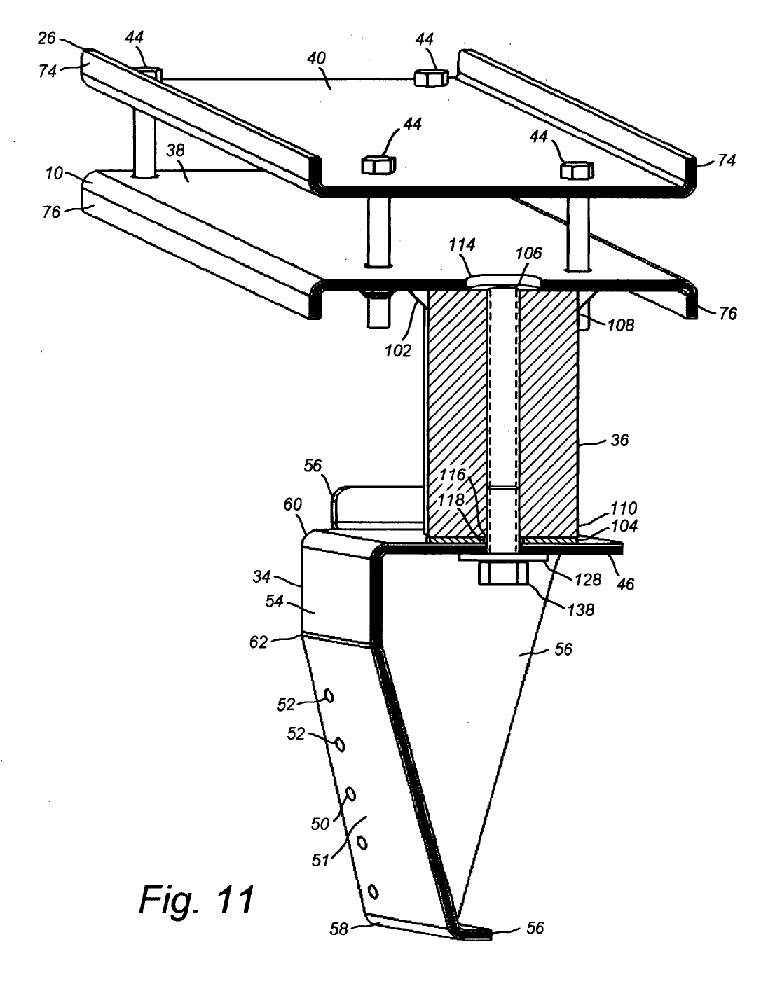

FIG. 11 is another view of the overhead mounting bracket 10 that illustrates the mounting frame member 26 in combination with the integrated receiver bracket 34. Here, the tubular aperture 106 in the spacing arm 36 is formed as an internally threaded aperture at least through the second end 110 adjacent to the receiver bracket 34. A shorter bolt 138 is inserted through the washer 128 and the clearance apertures 116, 118 through the low friction bushing 104 and the base plate portion 46 for securing the receiver bracket 34 to the spacing arm 36.

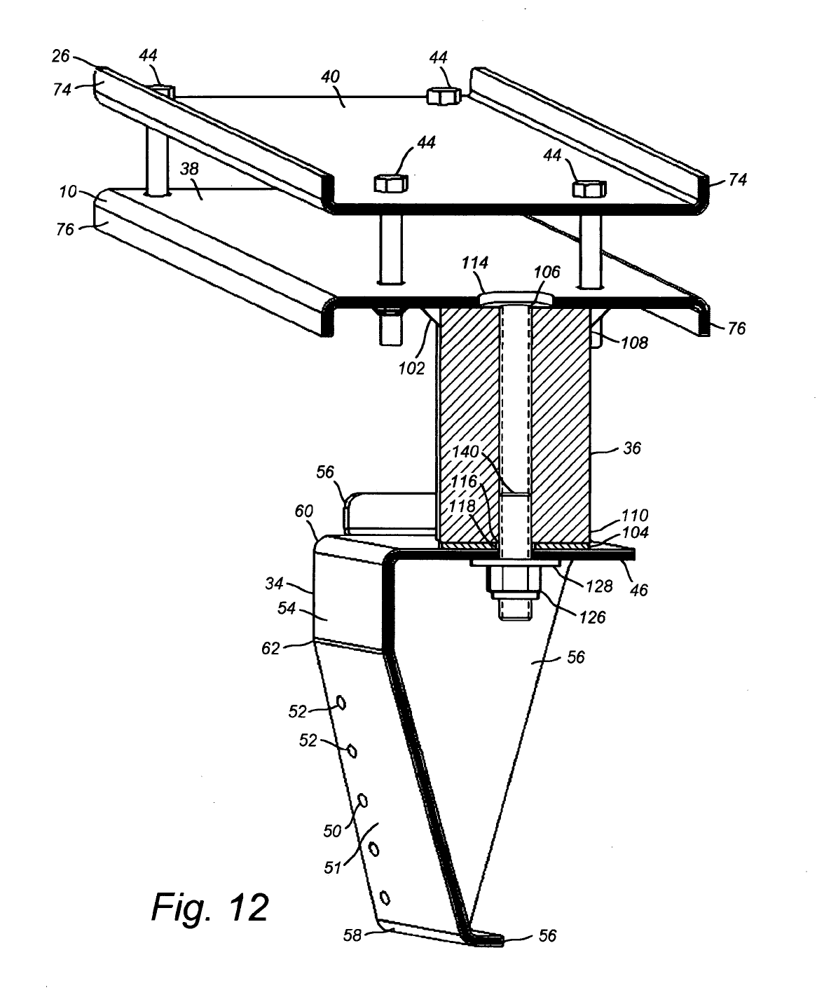

FIG. 12 is another view of the overhead mounting bracket 10 that illustrates the mounting frame member 26 in combination with the integrated receiver bracket 34. Here, a threaded stud 140 projects from the aperture 106 of the spacing arm 36 extends through the clearance apertures 116, 118 through the low friction bushing 104 and the base plate portion 46. The lock nut 126 and washer 128 secure the base plate portion 46 of the receiver bracket 34 relative to the stud 140.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. An overhead mounting bracket for mounting portable computers and other electronic computing devices in an on-road passenger vehicle such as an automobile, a pick-up truck, van or minivan in a position above the dashboard thereof, the mounting bracket comprising:
an integrated receiver bracket having a substantially rigid integral base plate portion adapted for attachment to a roof portion of a vehicle adjacent to an interior surface thereof, a substantially rigid integral mounting plate portion spaced away from the base plate portion and having a mounting face angularly inclined relative thereto and being adapted for attachment thereto of a cradle structured for holding a portable computer or other electronic computing device, and a substantially rigid integral spacing plate portion coupled between the mounting plate portion and the base plate portion and spacing the mounting plate portion away therefrom.

2. The overhead mounting bracket of claim 1 wherein the base plate portion of the receiver bracket further comprises a plurality of apertures formed therethrough, whereby the base plate portion is adapted for attachment to a roof portion of a vehicle adjacent to an interior surface thereof

3. The overhead mounting bracket of claim 1 wherein the mounting plate portion of the receiver bracket further comprises a plurality of apertures formed therein, whereby the mounting plate portion is adapted for attaching to the mounting face thereof a cradle structured for holding a portable computer or other electronic computing device.

4. The overhead mounting bracket of claim 3 wherein the mounting face of the mounting plate portion of the receiver bracket is further angularly inclined relative to the base plate portion thereof at an angle in the range of approximately ten to thirty degrees from perpendicular.

5. The overhead mounting bracket of claim 4, further comprising a substantially rigid mounting frame adapted for attachment to a roof portion of a vehicle adjacent to an interior surface thereof, and
a substantially rigid spacing arm coupled between the base plate portion of the receiver bracket and the mounting frame and spacing the base plate portion away therefrom.

6. The overhead mounting bracket of claim 5 wherein the spacing arm is further coupled for relative rotation between the base plate portion of the receiver bracket and the mounting frame.

7. The overhead mounting bracket of claim 6 wherein the first portion of the spacing arm and the second portion thereof are further coupled for relative rotation substantially about an axis between the mounting frame and the base plate portion of the receiver bracket.

8. The overhead mounting bracket of claim 6 wherein the mounting frame further comprises a first substantially rigid frame member and a second substantially rigid frame member, the second frame member being spaced away from the first frame member and coupled thereto by a plurality of fasteners coupled therebetween.

9. An overhead mounting bracket for mounting portable computers and other electronic computing devices in an on-road passenger vehicle such as an automobile, a pick-up truck, van or minivan in a position above the dashboard thereof, the mounting bracket comprising a receiver bracket comprising:
an integrated mounting plate having a substantially rigid integral base plate portion, a substantially rigid integral mounting plate portion spaced away from the base plate portion and having a mounting face formed thereon in an angularly inclined relationship to the base plate portion, and a substantially rigid integral spacing plate portion coupled between the mounting plate portion and the base plate portion and spacing the mounting plate portion away therefrom; and wherein:
the base plate further comprises first attachment means for attaching thereto a cradle for holding a portable computer or other electronic computing device; and
the mounting plate further comprises second attachment means for attaching to a roof portion of a vehicle adjacent to an interior surface thereof

10. The overhead mounting bracket of claim 9 wherein the second attachment means of the mounting plate portion further comprises a plurality of apertures formed through the mounting plate portion in a pattern corresponding to an interface portion of a cradle of a type for holding a portable computer or other electronic computing device.

11. The overhead mounting bracket of claim 10 wherein the mounting face of the mounting plate portion thereof is further angularly inclined relative to the base plate portion thereof at an obtuse angle.

12. The overhead mounting bracket of claim 11, further comprising a substantially rigid mounting frame comprising attachment means for attaching to a roof portion of a vehicle adjacent to an interior surface thereof, and
a substantially rigid spacing arm coupled between the base plate portion of the receiver bracket and the mounting frame and spacing the base plate portion away therefrom.

13. The overhead mounting bracket of claim 12 wherein the spacing arm further comprises a first end portion thereof fixedly coupled to the mounting frame; and
the base plate portion of the receiver bracket is relatively rotatably coupled to a second end portion of the spacing arm for relative rotation substantially about an axis between the mounting frame and the receiver bracket.

14. The overhead mounting bracket of claim 13 wherein the mounting frame further comprises a first substantially rigid frame plate and a second substantially rigid frame plate, the second frame plate being spaced away from the first frame plate and coupled thereto by a plurality of fasteners coupled therebetween.

15. An overhead mounting bracket for mounting portable computers and other electronic computing devices in a conventional on-road passenger vehicle such as an automobile, a pick-up truck, van or minivan in a position above the dashboard thereof, the mounting bracket comprising:
a mounting frame comprising a first substantially rigid frame member structured for substantially permanent attachment to a roof portion of a vehicle adjacent to an interior surface thereof,
a substantially rigid spacing arm substantially permanently coupled to the first frame member of the mounting frame opposite from the vehicle roof portion;
an integrated receiver bracket, comprising:
a substantially rigid integral base plate portion substantially permanently coupled to the spacing arm opposite from the first frame member of the mounting frame,
a substantially rigid integral mounting plate portion spaced away from the base plate portion opposite from the spacing arm and having a substantially planar mounting face formed thereon in an obtuse angularly inclined relationship to the spacing arm and being structured to substantially permanently receive an attachment adjacent thereto, and
a substantially rigid integral spacing plate portion coupled between the mounting plate portion and the base plate portion and spacing the mounting plate portion away therefrom.

16. The overhead mounting bracket of claim 15 wherein the mounting frame further comprises a second substantially rigid frame member spaced away from the first frame member opposite from the spacing arm; and
a plurality of fasteners substantially permanently coupling the first and second frame members in a spaced apart relationship.

17. The overhead mounting bracket of claim 15 wherein the spacing arm further comprises first and second spaced apart portions, the first portion being substantially permanently coupled to the first frame member of the mounting frame; and
the base plate portion of the receiver bracket being relatively rotatably coupled to the second portion of the spacing arm.

18. The overhead mounting bracket of claim 15, further comprising a cradle substantially permanently coupled to the mounting face of the mounting plate portion of the receiver bracket, the cradle being structured for holding a specific portable computer or other electronic computing device.

19. A method of suspending a portable computer and other electronic computing devices in a conventional on-road passenger vehicle such as an automobile, a pick-up truck, van or minivan in a position above the dashboard thereof, the suspending method comprising:
providing a mounting bracket, the mounting bracket comprising at least a receiver bracket comprising:
a substantially rigid base plate portion adapted for attachment to a roof portion of a motor vehicle adjacent to the interior surface thereof,
a substantially rigid mounting plate portion spaced away from the base plate portion and having a mounting face angularly inclined relative thereto and being adapted for attachment thereto of a cradle structured for holding a portable computer or other electronic computing device, and
a substantially rigid spacing plate portion coupled between the mounting plate portion and the base plate portion and spacing the mounting plate portion away therefrom;
substantially permanently coupling the mounting bracket to a roof portion of a vehicle adjacent to an interior surface thereof with the mounting face of the mounting plate portion being angularly inclined relative to the interior surface of the vehicle roof portion at an acute angle from perpendicular thereto in the range of approximately ten to thirty degrees; and
to the mounting face of the mounting plate portion of the mounting bracket, substantially permanently attaching a cradle structured for holding a portable computer or other electronic computing device having a display screen, the cradle being oriented on the mounting face of the mounting plate for holding the device with the display screen thereof in a substantially vertical viewing orientation relative to the vehicle having an upper portion of a view displayed thereon in an upper portion thereof adjacent to the vehicle roof portion and a lower portion thereof spaced away from the vehicle roof portion.

20. The method of claim 19, further comprising mounting a portable computer or other electronic computing device in the cradle with the display screen thereof in the substantially vertical viewing orientation.

21. The method of claim 19 wherein the coupling the mounting bracket to the roof portion of the vehicle adjacent to the interior surface thereof further comprises:
coupling a substantially rigid mounting frame to the roof portion of the vehicle adjacent to the interior surface thereof;
coupling a substantially rigid spacing arm to the mounting frame; and
coupling the base plate portion of the receiver bracket to the spacing arm in a spaced away relationship to the mounting frame.

22. The method of claim 21 wherein the coupling the mounting bracket to the roof portion of the vehicle adjacent to the interior surface thereof further comprises:
coupling a first portion of the spacing arm to the mounting frame; and
relatively rotatably coupling the base plate portion of the receiver bracket to a second portion of the spacing arm.

23. The method of claim 22 wherein the relatively rotatably coupling the base plate portion of the receiver bracket to a second portion of the spacing arm further comprises relatively rotatably coupling the base plate portion of the receiver bracket to a second portion of the spacing arm for relative rotation substantially about an axis between the mounting frame and the base plate portion of the receiver bracket.

24. The method of claim 23 wherein the relatively rotatably coupling the first and second portions of the spacing arm further comprises adjusting a relative rotatability between the first and second spacing arm portions.

25. The method of claim 21 wherein the coupling the mounting bracket to the roof portion of the vehicle adjacent to the interior surface thereof further comprises:
positioning a first substantially rigid frame member of the mounting frame adjacent to the interior surface of the roof portion of the vehicle;
positioning a second substantially rigid frame member of the mounting frame adjacent to an exterior surface of the roof portion of the vehicle spaced away from the interior surface thereof and substantially aligned with first frame member; and
coupling a plurality of fasteners between the first and second frame members.

26. The method of claim 19 wherein the substantially permanently coupling the mounting bracket to a roof portion of a vehicle adjacent to an interior surface thereof further comprises substantially permanently coupling the mounting bracket to a roof portion of a conventional on-road passenger vehicle such as an automobile, a pick-up truck, van or minivan adjacent to an interior surface thereof in a position above a dashboard thereof.
